(19) United States
(12) Patent Application Publication
(10) Pub. No.: US 2004/0101545 A1
(43) Pub. Date: May 27, 2004

(54) Composition and method

(76) Inventor: William D. Schoenherr, Hoyt, KS (US)

Correspondence Address: Colgate-Palmolive Company, 909 River Road, P.O. Box 1343, Piscataway, NJ, 08855-1343, US

(21) Appl. No.: 10/304,499

(22) Filed: Nov. 26, 2002

(51) Int. Cl. A23K 1/165; A23K 1/17; A23L 1/20

(52) U.S. Cl. 424/442; 426/630

(57) ABSTRACT

A composition comprising a pet dog or cat food source having fat wherein DAG is at a level in the fat wherein (1) the weight of an overweight dog or cat consuming the food source is reduced or (2) the normal weight of a pet dog or cat consuming the food source and having a propensity to weight gain is maintained or essentially maintained.

### BACKGROUND OF THE INVENTION

Standard weight loss pet foods utilize low calorie nutrient additions, such as fiber to decrease total caloric intake in dogs and cats and provide a meal that satiates the animal. Foods or ingredients that could increase caloric wasting in dogs and cats by (1) reducing fat digestibility or (2) reducing the efficiency of absorbed calories to be used for fat deposition, would be beneficial for weight loss.

Diacyglycerols (DAG) are closely related to triacylglycerols (TAG) in their physical characteristics, but they are absorbed and metabolized differently than TAG in humans. Both DAG and TAG are structurally similar; they each have a glycerol backbone with fatty acids attached to the carbon atoms through an ester bond. TAGs have three fatty acids, one attached to each carbon of the three-carbon glycerol molecule through an ester bond. DAGs have two fatty acids, attached to two of the carbons of the glycerol molecule through an ester bond. Consequently, a DAG can have fatty acids attached to the end and middle carbon of the glycerol (1,2 DAG) or to the two end carbons (1,3 DAG).

When TAGs are consumed by humans, they are digested in the stomach and small intestine by lipases. The lipases cleave the fatty acids off either end of the glycerol backbone leaving a 2-monoacylglyceride (2-MAG). The 2-MAGs and cleaved fatty acids are efficiently absorbed by the small intestine. When DAGs are consumed by humans, they also are digested in the stomach and small intestine by lipases, but the end result of digestion is not always a 2-MAG. A portion of the DAG is 1,3 DAG, which will yield either a 1-MAG or a 3-MAG, and this is absorbed less efficiently than the 2-MAG.

In dogs and cats, fats are not metabolized in the same manner upon digestion and absorption as in humans. For example, in dogs, the molecules in the blood that transport fats (lipoproteins) are different in structure and composition. Further, the lipoproteins in cats are different in structure and composition than humans or dogs. In addition, cats are known to be prone to hepatic lipidosis, a well-recognized syndrome characterized by accumulation of excess triglycerides in liver cells (hepatocytes) with resulting stoppage or slowing of the bile flow and liver dysfunction. Many cats with hepatic lipidosis are obese and often present with a history of prolonged anorexia. Yet, for both the dog and cat, fats are an indispensable nutrient in their diets.

Because of these differences in metabolizing fats by dogs and cats, the substitution of DAG for TAG in their oral food consumption would be at issue and certainly not obvious that such DAG containing fats will have assured effectiveness in weight reduction for the promotion of weight loss in dogs and cats in need thereof or in the maintenance of average weight in dogs and cats with a propensity to gain weight.

It has now been found that by using fats based on DAG as opposed to traditional TAG, in fats wherein such substitution can occur, weight loss in overweight dogs and cats can occur as well as the maintenance of normal weight in dogs and cats having a propensity to gain weight. These benefits occur without any seeming ill effects in the dog or cat. Once appropriate weight is achieved, the dog or cat is readily maintained at this weight. Fats where the substitution of TAG with DAG occurs are the supplemental fats added to the diet such as those entering the diet in other than protein sources and the like. Exemplary of such supplemental fats are those present in the diet as corn oil, soybean oil and flax oil or those fats sprayed on kibble so as to increase its palatability such as tallow, lard, poultry fat and choice white grease. DAG is introduced into fats through the following processes disclosed in the following patents and patent applications: U.S. Pat. Nos. 6,004,611; 6,106,879; 6,261,812; 6,310,100; 5,789,011; 5,514,405; 5,160,759; 5,077,077; 6,022,579; 6,287,624; 6,139,897; 6,326,050 B1; U.S. Pat. No. 4,976,984; EP0990391A1; WO01/13733A1; and JP2001204378A2 incorporated by reference. Ordinary fats utilizing TAG can be mixed with DAG prior to entry into the food source or each one placed into the food source without premixing.

### SUMMARY OF THE INVENTION

In accordance with the invention, there is a method for (1) reducing the weight of an overweight pet dog or cat of (2) maintaining or essentially maintaining the normal weight of a pet dog or cat that has a propensity for weight gain comprising orally administering fat to said dog or cat wherein DAG is at a level in the fat wherein (1) the weight of an overweight pet dog or cat is reduced or (2) the normal weight of a pet dog or cat having a propensity to gain weight is maintained or essentially maintained.

Further there is a composition comprising a pet dog or cat food source having fat wherein DAG is at a level in the fat wherein the weight of an overweight dog or cat consuming the food source is reduced or the minimal weight of a pet dog or cat consuming the food source and having a propensity to overweight is maintained or essentially maintained.

### DETAILED DESCRIPTION OF THE INVENTION

The differences between DAG and TAG are well known.

These differences can bring about a caloric value which is approximately ⅓ less than that of a similar TAG. Such lower caloric value thus brings about a reduction in weight in overweight pet dogs and cats as well as maintaining the weight in pet dogs and cats with a propensity to weight gain.

This is accomplished by replacing TAG with DAG in a supplemental fat source, which is then incorporated into a food source for the pet dog or cat. The food source includes an ordinary diet, a supplement, a treat and the like. In such food source, the DAG replaces the TAG in the supplemental added fat to an extent of about 20, 25, or 30 wt. % minimum to a maximum of about 90, 95, or 100 wt. %.

When the DAG containing food source is eaten by overweight pet dogs or cats a significant reduction in weight is observed. The food source should be provided to the pet dog or cat for a period of at least 60 days, and preferentially until the pet dog or cat reaches ideal body weight (defined as about 20% body fat or a body condition score of 3 on a 1 to 5 scale). The DAG can be fed essentially for the entire adult life of a pet dog or cat but a period of time no less than about 60 days or up to one year or more can bring about excellent weight loss results. For example, depending upon how overweight the dog or cat is, normal weight loss of 1 to 2% per week can be achieved by feeding the pet dog or cat a food supplemented with DAG.

The period of feeding the DAG for a pet dog or cat with a propensity to weight gain will maintain or essentially maintain its weight in the normal range through a continuous administration of the DAG at levels previously disclosed and times previously disclosed.

The use of the DAG does not appear to have any significant adverse effects upon the dog or cat even after usage for a period of time up to about 60 days or longer, for example at least up to a year.

Below are examples of the invention.

### EXAMPLE 1

Dog diet with DAG at 60% of the supplemental fat which is 5.25 wt. % of the food

| Ingredient | Amount % |
|---|---|
| Corn | 38.00 |
| Soybean Mill Run | 16.00 |
| Poultry By-Product Meal | 12.85 |
| Peanut Hulls | 10.00 |
| Corn Gluten Meal | 6.30 |
| DAG Oil | 3.15 |
| Soybean Oil | 2.10 |
| Soybean Meal | 5.00 |
| Palatability Enhancer System | 3.00 |
| Dried Egg | 1.00 |
| Vitamins and Minerals | 2.60 |

### EXAMPLE 2

Cat diet with DAG at 100% of the supplemental fat which is 5.75 wt. % of the food

| Ingredient | Amount % |
|---|---|
| Brewer's Rice | 31.85 |
| Corn Gluten Meal | 22.85 |
| Poultry By-Product Meal | 22.85 |
| Cellulose | 6.80 |
| DAG Oil | 5.75 |
| Corn | 3.40 |
| Soybean Mill Run | 1.80 |
| Palatability Enhancer System | 1.70 |
| Vitamins and Minerals | 3.00 |

### EXAMPLE 3

Treat for Dog

Dog treat with DAG at 100% of the supplemental fat which is 3.10 wt.% of the treat

| Ingredient | Amount % |
|---|---|
| Corn | 43.50 |
| Brewer's Rice | 19.00 |
| Poultry By-Product Meal | 17.20 |
| Cellulose | 5.50 |
| Chicken | 5.00 |
| Palatability Enhancer System | 3.50 |
| DAG Oil | 3.10 |
| Dried Egg | 1.60 |
| Vitamins and Minerals | 1.60 |

### EXAMPLE 4

Treat for Cat.

Cat treat with DAG at 50% of the supplemental fat which is 15 wt % of the treat

| Ingredient | Amount % |
|---|---|
| Poultry By-Product Meal | 36.85 |
| Corn | 20.00 |
| Brewer's Rice | 20.00 |
| Choice White Grease | 7.50 |
| DAG Oil | 7.50 |
| Corn Gluten Meal | 3.50 |
| Palatability Enhancer System | 2.50 |
| Vitamins and Minerals | 2.15 |

These food sources with DAG substituted for TAG are of value in treating cats with hepatic lipidosis or having a tendency to develop hepatic lipidosis. Positive results in returning a cat to normal liver function through use of DAG at the disclosed quantities and time periods can be achieved.

1. A composition comprising a pet dog or cat food source having fat wherein DAG is at a level in the fat wherein (1) the weight of an overweight dog or cat consuming the food source is reduced or (2) the normal weight of a pet dog or cat consuming the food source and having a propensity to weight gain is maintained or essentially maintained.

2. The composition in accordance with claim 1 wherein the weight of an overweight dog or cat consuming the food source is reduced.

3. The composition in accordance with claim 1 wherein the normal weight of a pet dog or cat consuming the food source and having a propensity to weight gain is maintained or essentially maintained.

4. A method for (1) reducing the weight of an overweight pet dog or cat or (2) maintaining or essentially maintaining the normal weight of a pet dog or cat that has a propensity for weight gain comprising orally administering to said dog or cat fat wherein DAG is at a level in the fat wherein the weight of an overweight pet dog or cat is reduced or the normal weight of a pet dog or cat having a propensity to gain weight is maintained or essentially maintained.

5. The method in accordance with claim 4 wherein the method is for reducing the weight of an overweight dog or cat.

6. The method in accordance with claim 4 wherein the method is for maintaining or essentially maintaining the normal weight of a dog or cat that has a propensity for weight gain.

7. A method for treating a cat with hepatic lipidosis which comprises feeding said cat fat wherein DAG is at a level in the fat that brings about normal liver function.
